(19) United States
(12) Patent Application Publication
(10) Pub. No.: US 2004/0213902 A1
(43) Pub. Date: Oct. 28, 2004

(54) System and method for manufacturing a fuel cell

(75) Inventors: Yoshiharu Ajiki, Fujimi-cho (JP); Shuhei Yamada, Chino-shi (JP); Hirotsuna Miura, Fujimi-cho (JP); Mitsuru Kuribayashi, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo, JP

(21) Appl. No.: 10/781,752

(22) Filed: Feb. 20, 2004

(30) Foreign Application Priority Data
Feb. 20, 2003 (JP) 2003-042663
Mar. 10, 2003 (JP) 2003-063357
Dec. 24, 2003 (JP) 2003-427068

(51) Int. Cl. B05D 5/12; B23P 19/00

(52) U.S. Cl. 427/115; 29/730

(57) ABSTRACT

The invention provides a fuel cell manufacturing apparatus having improved productivity and a fuel cell manufacturing method that uses the fuel cell manufacturing apparatus. The invention provides on a first substrate that is transferred by use of a belt conveyer that is driven by a driver based on a signal from a controller, by use of discharge devices, a first gas flow path for supplying a first reaction gas is formed. Subsequently, on the first substrate that is transferred by the belt conveyer, by use of discharge devices, a first current collecting layer and a first reaction layer are formed, respectively. In the next place, on the first substrate, by use of a discharge device, an electrolyte film is formed. Similarly, by use of discharge devices, a second reaction layer and a second current collecting layer are formed, respectively. In an assembly unit, a second substrate on which a second gas flow path is formed by use of discharge devices is disposed on a predetermined position on the first substrate, and thereby the manufacture of a fuel cell comes to completion.

### BACKGROUND OF THE INVENTION

1. Field of Invention

The present invention relates to fuel cell manufacturing apparatus that manufactures a fuel cell that generates electric power through a reaction of different kinds of reaction gases, a manufacturing method of a fuel cell in which different kinds of reaction gases are supplied to corresponding electrodes and electric power is generated owing to a reaction based on the supplied reaction gases, an electronics device provided with a fuel cell manufactured according to the method, and an automobile provided with a fuel cell manufactured according to the method.

2. Description of Related Art

Currently, there exist fuel cells in which an electrolyte that allows ions to go through is interposed between porous electrodes that allow electrons to go through. Among these fuel cells, there is one that generates electric power using hydrogen, natural gas or alcohol as a fuel. Among such fuel cells, in a fuel cell that uses, for instance, hydrogen as a fuel, a first reaction gas including hydrogen is supplied to one electrode, a second reaction gas including oxygen is supplied to the other electrode, and owing to a reaction based on hydrogen contained in the first reaction gas and oxygen contained in the second reaction gas electric power is generated.

Presently, research and development of a micro fuel cell that can be used with portable devices is in progress. The micro fuel cell can be manufactured by use of MEMS (Micro Electro Mechanical System) in which microfabrication technique that is used in semiconductor processes, and so on, is basically used. For instance, firstly, by use of the MEMS, on a surface of a substrate such as silicon and so on a fine gas flow path is formed. Subsequently, on the substrate thereon the gas flow path is formed a conductive layer, carbon electrodes and so on are formed. Finally, an electrolyte film that was formed in advance is interposed between two substrates thereon the electrodes and so on are formed followed by pressure bonding these, and thereby a micro fuel cell is manufactured. See, for example, Sang-Joon J Lee, Suk Won Cha, Amy Ching-Chien, O'Hayre and Fritz B. PrinzFactrical, Design Study of Miniature Fuel Cells with Michromachined Silicon Flow Structures, The 200^{th} Meeting of the Electrochemical Society, Abstract No. 452 (2001) and Amy Ching-Chien, Suk Won Cha, Sang-Joon J Lee, O'Hayre and Fritz B. PrinzPlaner, Interconnection of Multiple Polymer Electrolyte Membrane Micro Fabrication, The 200^{th} Meeting of The Electrochemical Society, Abstract No. 453 (2001).

In pressure bonding the electrolyte film, in order to inhibit the electrolyte film from being broken owing to the pressure bonding, an electrolyte film provided with the proton conductivity, the mechanical strength and the heat resistance is supplied. See, for example, JP-A-2001-113141.

Furthermore, in a fuel cell, platinum is in many cases used as a catalyst to accelerate a reaction. A reaction layer with the catalyst is formed between a substrate and an electrolyte film, the catalyst being coated by means of a spray coating method. See, for example, JP-A-2002-298860.

### SUMMARY OF THE INVENTION

Many devices that are used in the semiconductor processes are expensive. When a fuel cell is manufactured by use of techniques that are used in the semiconductor processes, such as the MEMS, the manufacturing cost becomes high. Furthermore, when the gas flow path is formed on a substrate by a technique of the MEMS, after the gas flow path is formed on the substrate, separately, an electrolyte film has to be pressure bonded. That is, the manufacturing process becomes complicate. Still furthermore, when a fuel cell is manufactured like this, there is a problem in that since the respective steps involving the manufacture of the fuel cell cannot be continuously carried out with one manufacturing apparatus, the productivity can be improved with difficulty.

Furthermore, when a catalyst is coated by a technique of spraying, since there is likelihood of the diffusion of the catalyst, in some cases, too much catalyst is coated. As a result, when an expensive catalyst, such as platinum and so on is used, as a result of an unnecessary increase in an amount of catalyst used, higher manufacturing cost of a fuel cell results.

An object of the present invention is to provide fuel cell manufacturing apparatus with which a fuel cell can be manufactured less expensively and with simplicity and the productivity thereof can be improved, and a method of manufacturing a fuel cell by use of the above fuel cell manufacturing apparatus. Furthermore, another object of the invention is to provide a fuel cell manufacturing method that allows manufacturing a fuel cell less expensively and with simplicity, and an electronics device provided with a fuel cell manufactured according to the above manufacturing method and an automobile provided with a fuel cell manufactured according to the above manufacturing method.

Fuel cell manufacturing apparatus of the present invention can include a first gas flow path formation unit that forms on a first substrate a first gas flow path for supplying a first reaction gas, a first current collecting layer formation unit that forms a first current collecting layer that collects electrons generated when the first reaction gas supplied through the first gas flow path reacts, a first reaction layer formation unit that forms a first reaction layer where the first reaction gas supplied through the first gas flow path reacts, an electrolyte film formation unit that forms an electrolyte film, a second gas flow path formation unit that forms on a second substrate a second gas flow path for supplying a second reaction gas, a second current collecting layer formation unit that forms a second current collecting layer that collects electrons generated when the second reaction gas supplied through the second gas flow path reacts, and a second reaction layer formation unit that forms a second reaction layer where the second reaction gas supplied through the second gas flow path reacts. At least one of the first gas flow path formation unit, the first current collecting layer formation unit, the first reaction layer formation unit, the electrolyte film formation unit, the second gas flow path formation unit, the second current collecting layer formation unit and the second reaction layer formation unit being formed by including a discharge device.

Furthermore, in fuel cell manufacturing apparatus involving the invention, the first gas flow path formation unit, the first current collecting layer formation unit, the first reaction layer formation unit, the electrolyte film formation unit, the second gas flow path formation unit, the second current collecting layer formation unit and the second reaction layer formation unit are continuously disposed as one manufacturing line.

According to the fuel cell manufacturing apparatus, at least one of the first gas flow path formation unit, the first current collecting layer formation unit, the first reaction layer formation unit, the electrolyte film formation unit, the second gas flow path formation unit, the second current collecting layer formation unit and the second reaction layer formation unit is formed including a discharge device, and the respective units are continuously arranged as one manufacturing line. Accordingly, without using, for instance, the MEMS that is used in the semiconductor manufacturing process, a fine gas flow path can be easily formed by use of an ink jet type discharge device, resulting in reducing the manufacturing cost of the fuel cell. Furthermore, since the respective units that constitute the fuel cell manufacturing apparatus are continuously arranged, the fuel cell can be continuously manufactured. Accordingly, the productivity of the fuel cell can be improved.

Furthermore, in a fuel cell manufacturing apparatus according to the invention, the respective units of the first gas flow path formation unit, the first current collecting layer formation unit, the first reaction layer formation unit, the electrolyte film formation unit, the second gas flow path formation unit, the second current collecting layer formation unit and the second reaction layer formation unit are connected therebetween through a transfer unit.

According to the fuel cell manufacturing apparatus, the respective units that constitute the fuel cell manufacturing apparatus are connected therebetween through a transfer unit, for instance, a belt conveyer. Accordingly, for instance, like a substrate thereon a gas flow path is formed at the first gas flow path formation unit being transferred up to the first current collecting layer formation unit through the belt conveyer and so on, between the respective units arranged as one manufacturing line, the substrate can be smoothly transferred.

Furthermore, a fuel cell manufacturing method according to the invention is a fuel cell manufacturing method that uses the fuel cell manufacturing apparatus according to the invention, wherein a step of forming the first gas flow path, a step of forming the first current collecting layer, a step of forming the first reaction layer, a step of forming the electrolyte layer, a step of the second gas flow path, a step of forming the second current collecting layer, and a step of forming the second reaction layer are continuously carried out.

According to the fuel cell manufacturing method, a step of forming the first gas flow path, a step of forming the first current collecting layer, a step of forming the first reaction layer, a step of forming the electrolyte layer, a step of the second gas flow path, a step of forming the second current collecting layer, and a step of forming the second reaction layer are continuously carried out by use of the fuel cell manufacturing apparatus according to the invention. Accordingly, the productivity of fuel cells can be improved.

Furthermore, a fuel cell manufacturing method involving the invention can include a step of forming a first gas flow path by which on a first substrate a first gas flow path for supplying a first reaction gas is formed, a step of forming a first current collecting layer by which a first current collecting layer that collects electrons generated when the first reaction gas supplied through the first gas flow path reacts is formed, a step of forming a first reaction layer by which a first reaction layer where the first reaction gas supplied through the first gas flow path reacts is formed, a step of forming an electrolyte film by which an electrolyte film is formed, a step of forming a second gas flow path by which on a second substrate a second gas flow path for supplying a second reaction gas is formed, a step of forming a second current collecting layer by which a second current collecting layer that supplies electrons necessary when the second reaction gas supplied through the second gas flow path reacts is formed, and a step of forming a second reaction layer by which a second reaction layer where the second reaction gas supplied through the second gas flow path reacts is formed. At least in one of the step of forming the first gas flow path, the step of forming the first current collecting layer, the step of the forming the first reaction layer, the step of forming the electrolyte film, the step of forming the second gas flow path, the step of forming the second current collecting layer and the step of forming the second reaction layer, a discharge device is used.

According to the fuel cell manufacturing method, at least in one step of the step of forming the first gas flow path, the step of forming the first current collecting layer, the step of forming the first reaction layer, the step of forming the electrolyte film, the step of forming the second gas flow path, the step of forming the second current collecting layer and the step of forming the second reaction layer, a discharge device is used. Accordingly, without using, for instance, the MEMS that is used in the semiconductor manufacturing process, a fine gas flow path can be easily formed by use of an ink jet type discharge device, resulting in reducing the manufacturing cost of the fuel cells.

Furthermore, according to a fuel cell manufacturing method involving the invention, in the step of forming the first current collecting layer, a first current collecting layer is formed on the first substrate. In the step of forming the first reaction layer, a first reaction layer can be formed on the first current collecting layer. In the step of forming the electrolyte film, an electrolyte film can be formed on the first reaction layer. In the step of forming the second reaction layer, a second reaction layer can be formed on the electrolyte film. In the step of forming a second current collecting layer, a second current collecting layer can be formed on the second reaction layer, and the second substrate can be arranged on the second current collecting layer.

According to the fuel cell manufacturing method, on a first substrate, a first current collecting layer, a first reaction layer, an electrolyte film, a second reaction layer and a second current collecting layer are sequentially formed, and on the second current collecting layer a second substrate thereon a second gas flow path is formed is disposed. Accordingly, without going through a process where an electrolyte film is separately pressure bonded on a substrate thereon a gas flow path is formed and a current collecting layer and a reaction layer are formed, according to a simple manufacturing method, a fuel cell can be easily manufactured.

Furthermore, according to a fuel cell manufacturing method involving the invention, on the first substrate the first current collecting layer, the first reaction layer and the electrolyte film are sequentially formed, on the second substrate the second current collecting layer, the second reaction layer and the electrolyte film are sequentially formed, and the electrolyte film on the first substrate and the electrolyte film on the second substrate are connected.

According to the fuel cell manufacturing method, the substrates on each of which the current collecting layer, the reaction layer and the electrolyte film are formed are connected with the electrolyte films disposed inside thereof. Accordingly, for instance, when the first substrate and the second substrate are processed in parallel, a fuel cell can be rapidly manufactured.

Furthermore, a fuel cell manufacturing method according to the invention can further include a step of disposing, in the first gas flow path formed in the step of forming the first gas flow path, a first supporting member that supports the first current collecting layer, and a step of disposing, in the second gas flow path formed in the step of forming the second gas flow path, a second supporting member that supports the second current collecting layer.

According to the fuel cell manufacturing method, a supporting member that supports the current collecting layer is disposed in the gas flow path. Accordingly, the current collecting layer is inhibited from clogging the gas flow path formed on the substrate, and thereby the gas flow path can be assuredly secured so that the reaction gas may be appropriately supplied.

Furthermore, a fuel cell manufacturing method involving the invention is a manufacturing method of a fuel cell in which at least one current collecting layer, at least one gas diffusion layer, at least one reaction layer and an electrolyte layer are formed between substrates. In the step of forming at least one layer of the current collecting layer, the gas diffusion layer, the reaction layer and the electrolyte layer, a discharge device is used. Still furthermore, the fuel cell manufacturing method involving the invention can include a step of forming the gas diffusion layer on the current collecting layer, a step of forming the reaction layer on the gas diffusion layer and a step of forming the electrolyte layer on the reaction layer.

According to the fuel cell manufacturing method, since a discharge device is used in a step of forming at least one layer, without using the MEMS that is used in the semiconductor manufacturing process, for instance, a smaller size fuel cell in which a fine gas flow path is formed can be easily manufactured.

Furthermore, a fuel cell manufacturing method involving the invention is a method of manufacturing a fuel cell in which between a pair of substrates on each of which a gas flow path is formed, at least one current collecting layer, at least one gas diffusion layer, at least one reaction layer and an electrolyte layer are formed. In the step of forming at least one of the supporting member disposed in the gas flow path, the current collecting layer, the gas diffusion layer, the reaction layer and the electrolyte layer, a discharge device is used. Still furthermore, according to the fuel cell manufacturing method involving the invention, the current collecting layer is formed on the supporting member, the gas diffusion layer is formed on the current collecting layer, the reaction layer is formed on the gas diffusion layer and the electrolyte layer is formed on the reaction layer.

According to the fuel cell manufacturing method, since a discharge device is used at least in one of the layer forming steps, without using the MEMS that is used in the semiconductor manufacturing process, for instance, a smaller size fuel cell in which a fine gas flow path is formed can be easily manufactured. Furthermore, since the supporting member is disposed in the gas flow path, material that constitutes the gas diffusion layer such as carbon particles is appropriately inhibited from clogging a space in the gas flow path.

Still furthermore, an electronics device involving the invention is provided with as a power source a fuel cell manufactured according to the manufacturing method involving the invention. According to the electronics device, clean energy that appropriately cares for the global environment can be provided as a power source.

Still furthermore, an automobile involving the invention is provided with as a power source a fuel cell manufactured according to the manufacturing method involving the invention. According to the automobile, clean energy that appropriately cares for the global environment can be provided as a power source.

### BRIEF DESCRIPTION OF THE DRAWINGS

The invention will be described with reference to the accompanying drawings, wherein like numerals reference like elements, and wherein:

FIG. 1 is a diagram showing an example of a manufacturing line of a fuel cell according to a mode for carrying out the invention;

FIG. 2 is a schematic diagram of an ink jet type discharge device according to a mode for carrying out the invention;

FIG. 3 is a flowchart of a manufacturing method of a fuel cell according to a mode for carrying out the invention;

FIGS. 4A and 4B are diagrams for explaining formation treatment of a gas flow path according to a mode for carrying out the invention;

FIGS. 5A and 5B are other diagrams for explaining formation treatment of a gas flow path according to a mode for carrying out the invention;

FIG. 6 is an end view of a substrate in the course of manufacturing a fuel cell according to a mode for carrying out the invention;

FIG. 7 is an end view of a substrate in the course of manufacturing a fuel cell according to a mode for carrying out the invention;

FIG. 8 is an end view of a substrate in the course of manufacturing a fuel cell according to a mode for carrying out the invention;

FIG. 9 is an end view of a substrate in the course of manufacturing a fuel cell according to a mode for carrying out the invention;

FIG. 10 is an end view of a substrate in the course of manufacturing a fuel cell according to a mode for carrying out the invention;

FIG. 11 is an end view of a substrate in the course of manufacturing a fuel cell according to a mode for carrying out the invention;

FIG. 12 is an end view of a substrate in the course of manufacturing a fuel cell according to a mode for carrying out the invention;

FIG. 13 is an end view of a substrate in the course of manufacturing a fuel cell according to a mode for carrying out the invention;

FIG. 14 is an end view of a substrate of a fuel cell according to a mode for carrying out the invention; and

FIG. 15 is a diagram of a large size fuel cell obtained by laminating fuel cells according to a mode for carrying out the invention.

### DETAILED DESCRIPTION OF PREFERRED EMBODIMENTS

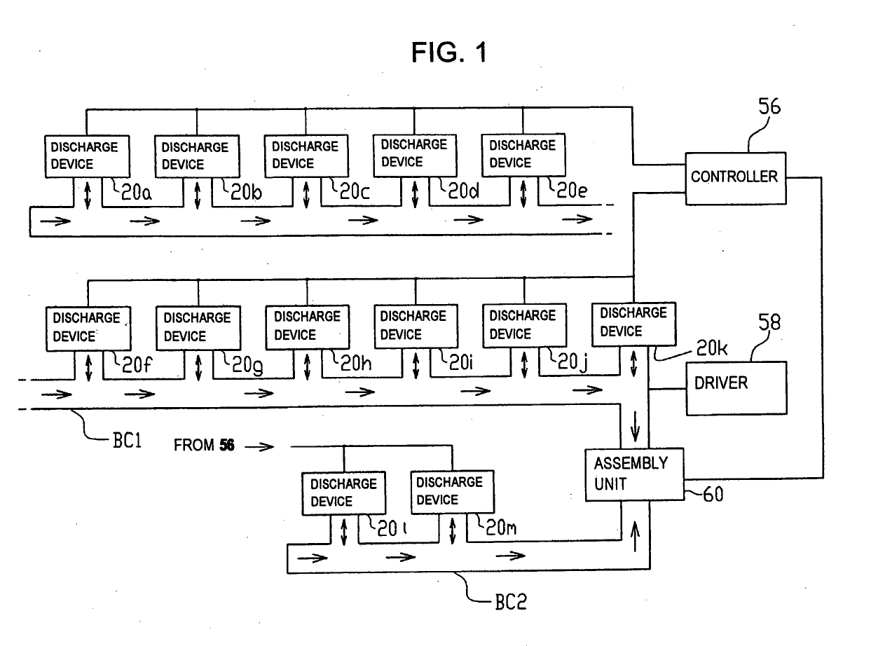

In the following, fuel cell manufacturing methods involving modes for carrying out the invention will be explained. FIG. 1 is a diagram showing one example of a configuration of a fuel cell manufacturing line that implements steps of manufacturing a fuel cell involving a mode for carrying out the invention. As shown in FIG. 1, the fuel cell manufacturing line includes discharge devices 20a through 20m that are used respectively in the respective steps, a belt conveyer BC1, a transfer device, for connecting the discharge devices 20a through 20k, a belt conveyer BC2, a transfer device, for connecting discharge devices 20l and 20m, a driver unit 58 that drives the belt conveyers BC1 and BC2, an assembly unit 60 that assembles a fuel cell, and a control unit 56 that controls the whole of the fuel cell manufacturing line.

The discharge devices 20a through 20k are arranged along the belt conveyer BC1 in a line with a predetermined separation, and the discharge devices 20l and 20m are arranged along the belt conveyer BC2 in a line with a predetermined separation. Furthermore, the control unit 56 is connected to the respective discharge devices 20a through 20m, the driver unit 58 and the assembly unit 60. On the basis of a control signal from the control unit 56, the belt conveyer BC1 is driven so as to transfer a substrate of a fuel cell (hereinafter simply referred to as “substrate”) to each of the discharge devices 20a through 20k to apply treatment at each of the discharge devices 20a through 20k. Similarly, on the basis of a control signal from the control unit 56, the belt conveyer BC2 is driven so as to transfer a substrate to each of the discharge devices 20l and 20m to apply treatment at each of the discharge devices 20l and 20m. Furthermore, in the assembly unit 60, with substrates transferred through the belt conveyers BC1 and BC2 based on a control signal from the control unit 56, a fuel cell is assembled.

In the fuel cell manufacturing line, the discharge device 20a coats on a substrate a resist solution for forming a gas flow path, the discharge device 20b applies etching to form the gas flow path, and the discharge device 20c coats supporting carbon for supporting a current collecting layer.

Furthermore, the discharge device 20d applies treatment for forming a current collecting layer, the discharge device 20e applies treatment to form a gas diffusion layer, the discharge device 20f applies treatment to form a reaction layer, and the discharge device 20g applies treatment for forming an electrolyte layer. Still furthermore, the discharge device 20h applies treatment for forming a reaction layer, the discharge device 20i applies treatment to form a gas diffusion layer, the discharge device 20j applies treatment for forming a current collecting layer, and the discharge device 20k applies treatment for coating supporting carbon.

Furthermore, the discharge device 20l coats a resist solution for forming a gas flow path on a substrate, and the discharge device 20m applies etching for forming a gas flow path. When the discharge devices 20a through 20k apply treatment on the first substrate, the discharge devices 20l and 20m apply treatment for forming a gas flow path on the second substrate.

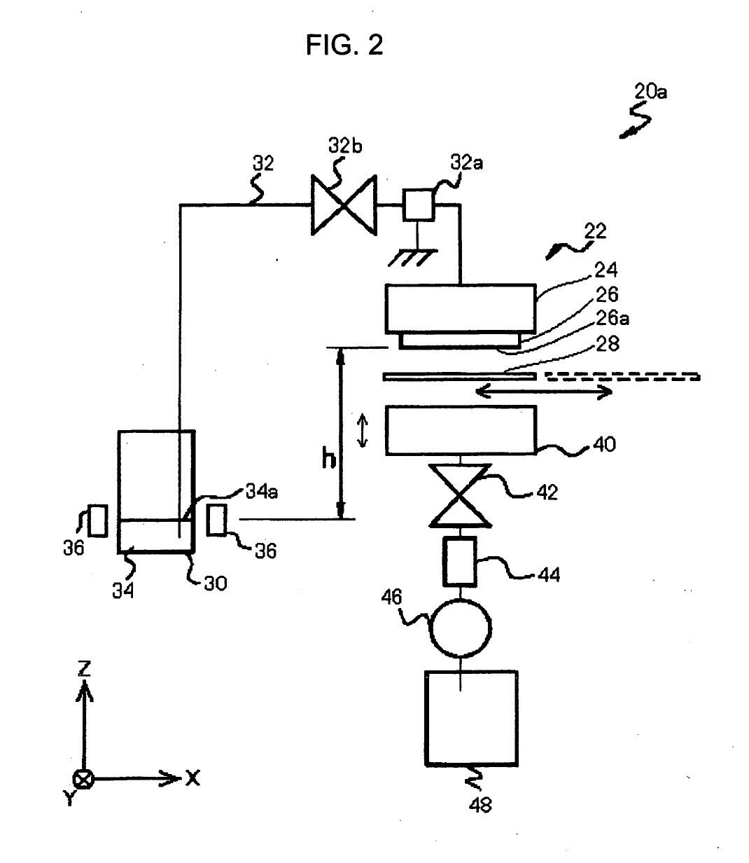

FIG. 2 is a schematic diagram showing a configuration of an ink jet type discharge device 20a that is used in manufacturing a fuel cell involving a mode for carrying out the invention. The discharge device 20a is provided with an ink jet head 22 that discharges an ejection on a substrate. The ink jet head 22 is provided with a head body 24 and a nozzle formation surface 26 on which a lot of nozzles are formed to discharge the ejection. From the nozzles on the nozzle formation surface 26, the ejection, that is, a resist solution that is coated on the substrate when a gas flow path for supplying a reaction gas is formed on the substrate is discharged.

Furthermore, the discharge device 20a is provided with a table 28 thereon the substrate is placed. The table 28 is disposed capable of moving in a predetermined direction, for instance, an X-axis direction, a Y-axis direction and a Z-axis direction. Still furthermore, the table 28, by moving in a direction along an X-axis as shown with an arrow mark in the drawing, allows placing the substrate transferred by the belt conveyer BC1 on the table 28 and takes the substrate inside of the discharge device 20a.

Furthermore, the ink jet head 22 is connected to a tank 30 that reserves a resist solution that is the ejection being discharged from the nozzles formed on the nozzle formation surface 26. That is, the tank 30 and the ink jet head 22 are connected through an ejection transfer pipe 32 that transfers the ejection. Still furthermore, the ejection transfer pipe 32 includes an ejection flow path earth joint 32a that inhibits the inside of the flow path of the ejection transfer pipe 32 from taking a charge and a head air bubble removing valve 32b. The head air bubble removing valve 32b is used when the ejection inside of the ink jet head 22 is sucked with a suction cap 40 described later. That is, when the ejection inside of the ink jet head 22 is sucked by use of the suction cap 40, the head air bubble removing valve 32b is closed so that the ejection may not flow in from the tank 30 side. When after that the ejection is sucked by use of the suction cap 40, the flow rate of the ejection being sucked is increased, resulting in rapidly exhausting air bubbles inside of the ink jet head 22.

Still furthermore, the discharge device 20a is provided with a liquid level control sensor 36 that controls an amount of the ejection accommodated in the tank 30, that is, a height of a liquid level 34a of the resist solution accommodated in the tank 30. The liquid level control sensor 36 controls difference h between heights (hereinafter referred to as “head value”) of a tip end portion 26a of the nozzle formation surface 26 that the ink jet head 22 has and the liquid level 34a inside of the tank 30 so as to be within a predetermined range. When a height of the liquid level 34a is controlled, the ejection 34 in the tank 30 is sent to the ink jet head 22 at a pressure within a predetermined range. Thus, by sending the ejection 34 under a pressure within a predetermined range, the ejection 34 can be stably discharged from the ink jet head 22.

Furthermore, the suction cap 40 that sucks the ejection inside of the nozzles of the ink jet head 22 is disposed while facing the nozzle formation surface 26 of the ink jet head 22 with a predetermined distance separated therefrom. The suction cap 40 is constituted movable in a direction along the Z-axis shown with an arrow mark in the drawing, comes into close contact with the nozzle formation surface 26 so as to surround a plurality of nozzles formed on the nozzle formation surface 26 and to form a closed space with the nozzle formation surface 26, and thereby the nozzles can be shielded from ambient air. The suction of the ejection inside of the nozzles of the ink jet head 22 due to the suction cap 40 is carried out in a state where the ink jet head 22 is not discharging the ejection 34, for instance, when the ink jet head 22 recedes to a shelter and the table 28 gets under shelter at a position shown by a dotted line.

Furthermore, below the suction cap 40, a flow path is disposed, and the flow path is provided with a suction valve 42, a suction pressure sensor 44 for detecting suction defect and a suction pump 46 made of a tube pump and so on. Still furthermore, the ejection 34 that is sucked by the suction pump 46 and the like and transferred through the flow path is accommodated in a waste liquid tank 48.

Since the discharge devices 20b through 20m are constituted similarly to the discharge device 20a, the explanation thereof will be omitted. However, in the explanation below, in the respective constructions of the discharge devices 20b through 20m, reference numerals same as that used in the respective constructions in the explanation of the discharge device 20a will be used. In each of tanks 30 provided respectively to the discharge devices 20b through 20m, an ejection necessary for the predetermined treatment that is carried out in each of the discharge devices 20b through 20m is reserved. For instance, in each of the tanks 30 of the discharge devices 20b and 20m, an ejection for etching that is carried out when the gas flow path is formed is reserved, and in each of the tanks 30 of the discharge devices 20c and 20k, an ejection for forming the supporting carbon is reserved. Furthermore, in each of the tanks 30 of the discharge devices 20d and 20j, an ejection for forming a current collecting layer is accommodated. Still furthermore, in each of the tanks 30 of the discharge devices 20e and 20i, an ejection for forming a gas diffusion layer is reserved, in each of the tanks 30 of the discharge devices 20f and 20h, an ejection for forming a reaction layer is reserved, and in the tank 30 of the discharge device 20g, an ejection for forming an electrolyte film is reserved. Still furthermore, in the tank 30 of the discharge device 20l, an ejection similar to that that is accommodated in the tank 30 of the discharge device 20a and is used to form a gas flow path on the substrate is reserved.

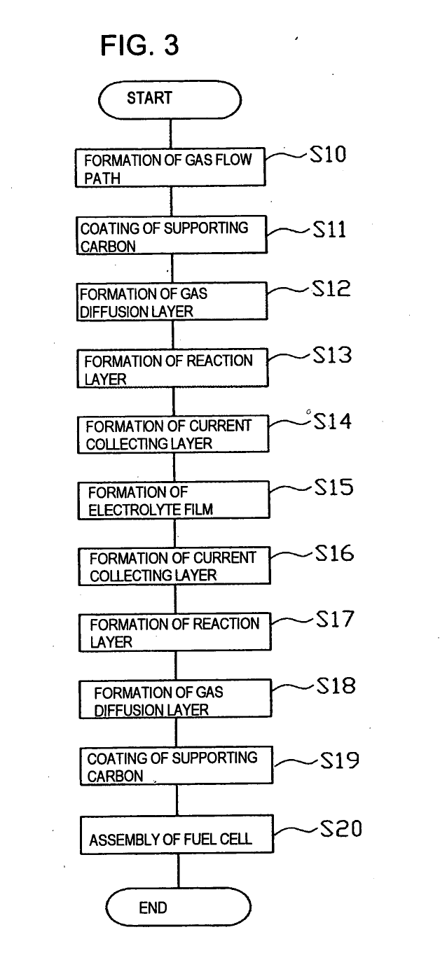

In the next place, with reference to a flow chart of FIG. 3 and drawings, a fuel cell manufacturing method that uses discharge devices 20a through 20m involving a mode for carrying out the invention will be explained.

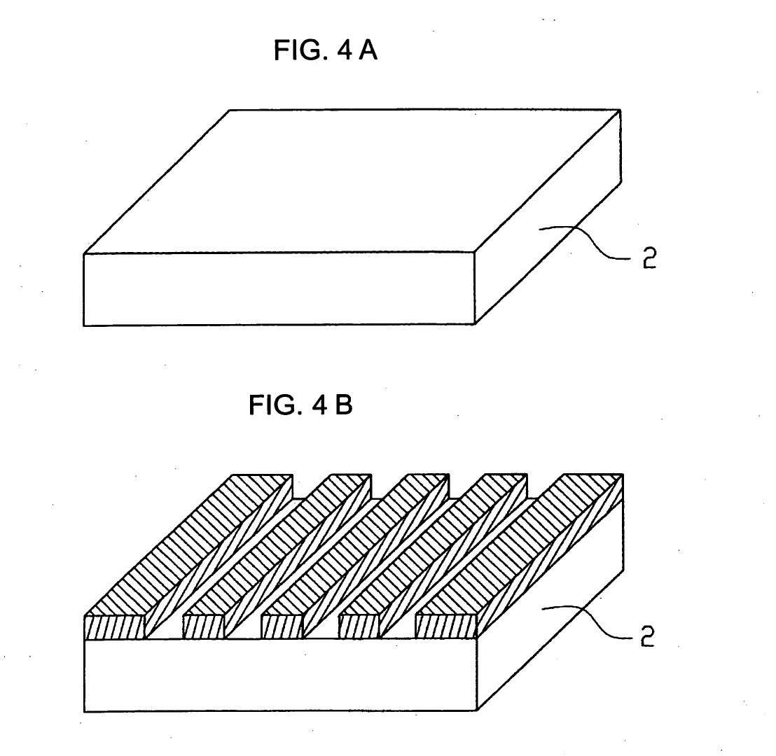

First, a gas flow path for supplying a reaction gas to a substrate is formed (step S10). That is, as shown in FIG. 4A, a rectangular plane table-like substrate (first substrate) 2 made of, for instance, silicon material is transferred to a discharge device 20a by means of a belt conveyer BC1. The substrate 2 transferred by the belt conveyer BC1 is placed on a table 28 of the discharge device 20a and taken inside of the discharge device 20a. In the discharge device 20a, a resist solution that is reserved in a tank 30 is discharged through nozzles on a nozzle formation surface 26 and coated at a predetermined position on a top surface of the substrate 2 placed on the table 28. Here, the resist solution, as shown in FIG. 4B, is coated from a near side to a remote side in the drawing into straight lines separated with a predetermined separation. That is, in the substrate 2, with a portion where a gas flow path (first gas flow path) for supplying a first reaction gas that contains, for instance, hydrogen is formed remained, only on a portion other than the above the resist solution is coated.

Subsequently, the substrate 2 (FIG. 4B) on the predetermined position of which the resist solution was coated is transferred up to a discharge device 20b by means of the belt conveyer BC1, placed on a table 28 of the discharge device 20b and taken inside of the discharge device 20b. In the discharge device 20b, an etching solution, for instance, an aqueous solution of hydrofluoric acid, that is accommodated in the tank 30 and used for forming a gas flow path is discharged through nozzles on the nozzle formation surface 26, and thereby the whole top surface of the substrate 2 placed on the table 28 is coated.

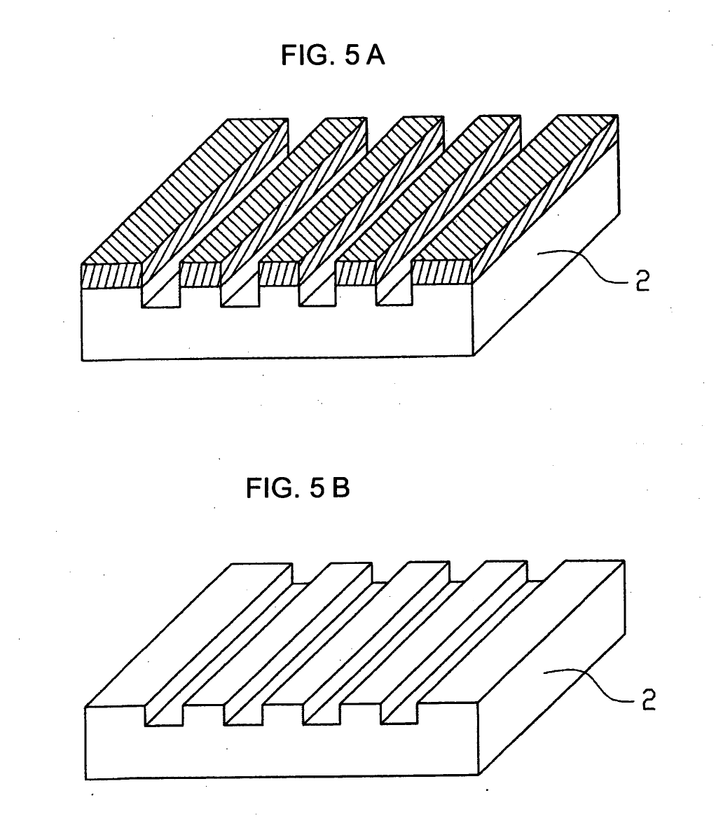

Here, on the substrate 2, on a portion other than that where the gas flow path is formed, a resist solution is coated. Accordingly, a portion where the resist solution is not coated is etched with an aqueous solution of hydrofluoric acid, and thereby, as shown in FIG. 5A, a gas flow path is formed. That is, the gas flow path that has a U-shaped cross section and extends from one side surface of the substrate 2 to the other side surface thereof is formed. Furthermore, as shown in FIG. 5A, the substrate 2 on which the gas flow path is formed is washed to remove the resist in a not shown cleaning unit. Subsequently, as shown in FIG. 5B, the substrate 2 on which the gas flow path was formed is transferred from the table 28 to the belt conveyer BC1, followed by transferring to the discharge device 20c by means of the belt conveyer BC1.

In the next place, in order to inhibit the gas flow path formed on the substrate 2 in step S10 from being clogged by the current collecting layer, supporting carbon (the first supporting member) that supports the current collecting layer is coated in the gas flow path (step S11). That is, firstly, the substrate 2 transferred up to the discharge device 20c by means of the belt conveyer BC1 is placed on the table 28 and taken inside of the discharge device 20c. In the discharge device 20c, supporting carbon 4 that is reserved in the tank 30 is discharged through nozzles on the nozzle formation surface 26 and thereby coated in the gas flow path formed on the substrate 2. Here, as the supporting carbon 4, porous carbon having a predetermined magnitude, for instance, a particle diameter in the range of substantially from 1 to 5 μm is used. That is, in order that the current collecting layer may be inhibited from clogging the gas flow path and the reaction gas may assuredly flow inside of the gas flow path, as the supporting carbon 4, the porous carbon having a predetermined magnitude is used.

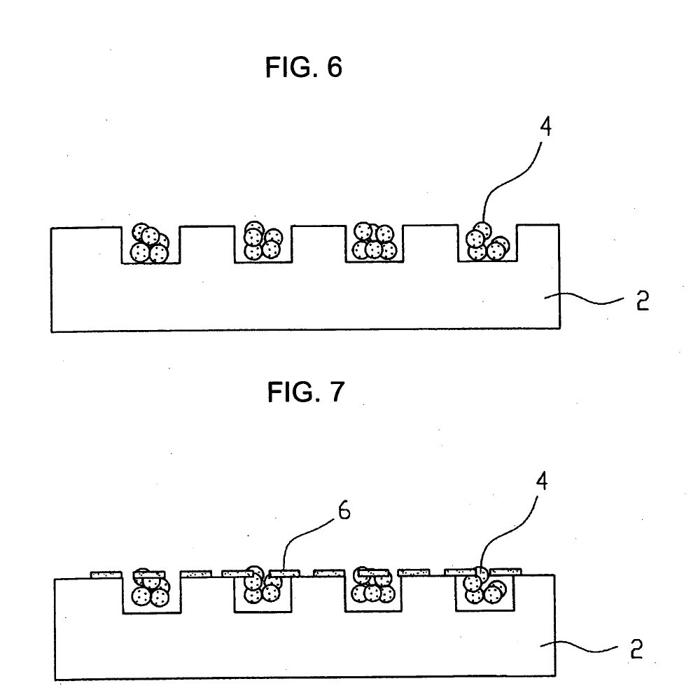

FIG. 6 is an end view of the substrate 2 on which the supporting carbon 4 is coated. As shown in the FIG. 6, when the supporting carbon 4 is coated in the gas flow path, the current collecting layer formed on the substrate 2 is inhibited from falling into the gas flow path. The substrate 2 on which the supporting carbon 4 was coated is transferred from the table 28 to the belt conveyer BC1 and the belt conveyer BC1 transfers it to the discharge device 20d.

Subsequently, on the substrate 2, a current collecting layer (first current collecting layer) that collects electrons generated owing to a reaction of the reaction gas is formed (step S12). That is, firstly, the substrate 2 transferred up to the discharge device 20d by means of the belt conveyer BC1 is placed on the table 28 and taken into the discharge device 20d. In the discharge device 20d, material that is reserved in the tank 30 and forms a current collecting layer 6, for instance, conductive material such as copper and so on is discharged through nozzles of the nozzle formation surface 26 on the substrate 2 disposed on the table 28. At this time, the conductive material is discharged into a shape that may not disturb the diffusion of the reaction gas supplied into the gas flow path, for instance, a mesh-like shape, and thereby the current collecting layer 6 is formed.

FIG. 7 is an end view of the substrate 2 on which the current collecting layer 6 is formed. As shown in the FIG. 7, the current collecting layer 6 is supported by the supporting carbon 4 in the gas flow path formed on the substrate 2 and thereby inhibited from falling into the gas flow path. The substrate 2 on which the current collecting layer 6 is formed is transferred from the table 28 to the belt conveyer BC1 and the belt conveyer BC1 transfers it to the discharge device 20e.

In the next place, on the current collecting layer 6 formed in the step S12, a gas diffusion layer that allows a reaction gas that is supplied through the gas flow path formed on the substrate 2 to diffuse is formed (step S13). That is, first, the substrate 2 transferred up to the discharge device 20e by means of the belt conveyer BC1 is placed on the table 28 and taken in the discharge device 20e. In the discharge device 20e, material that is reserved in the tank 30 and is used to form a gas diffusion layer 8, for instance, carbon particles are discharged through nozzles on the nozzle formation surface 26 on the current collecting layer 6, and thereby the gas diffusion layer 8 that is used to cause the diffusion of a reaction gas (first reaction gas) supplied through the gas flow path is formed.

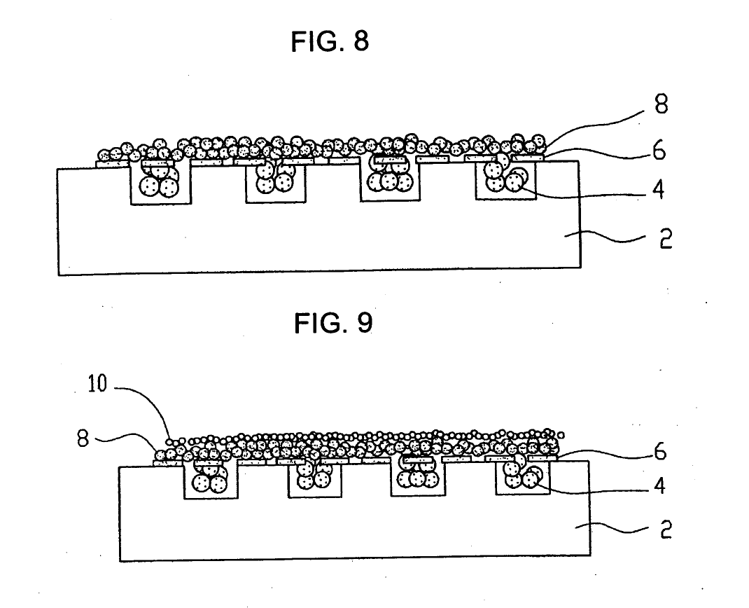

FIG. 8 is an end view of the substrate 2 on which the gas diffusion layer 8 is formed. As shown in the FIG. 8, for instance, carbon particles that work also as an electrode are discharged on the current collecting layer 6, and thereby the gas diffusion layer 8 for causing the diffusion of the reaction gas is formed. Here, as the carbon particles that constitute the gas diffusion layer 8, carbon that has a magnitude to an extent that can cause sufficient diffusion of the reaction gas supplied through the gas flow path and is porous is used. For instance, porous carbon that is smaller than the supporting carbon 4 and has a particle diameter in the range of substantially from 0.1 to 1 μm is used. The substrate 2 thereon the gas diffusion layer 8 is formed is transferred from the table 28 to the belt conveyer BC1 followed by transferring to the discharge device 20f by means of the belt conveyer BC1.

Next, on the gas diffusion layer 8 formed in the step S13, a reaction layer (first reaction layer) where the reaction gas supplied through the gas flow path formed on the substrate 2 reacts is formed (step S14). That is, the substrate 2 transferred up to the discharge device 20f by technique of the belt conveyer BC1 is placed on the table 28 and taken into the discharge device 20f. In the discharge device 20f, material that is reserved in the tank 30 and used to form a reaction layer such as carbon particles carrying fine platinum particles for catalyst (platinum-carried carbon) having a particle size in the range of substantially from several to several tens nm is discharged on the gas diffusion layer 8, and thereby a reaction layer 10 is formed. As the platinum-carried carbon that carries fine platinum particles, carbon particles similar to those that constitute the gas diffusion layer 8, that is, ones that have the similar particle size and are porous are used. The reaction layer 10 may be formed also in such manner that fine platinum particles are dispersed in a solvent by adding a dispersing agent, this solution is coated on the gas diffusion layer 8 followed by heating, for instance, at 200 degree centigrade in a nitrogen atmosphere to remove the dispersing agent, and thereby the reaction layer 10 is formed. In this case, the fine platinum particles as the catalyst are adhered onto surfaces of carbon particles that constitute the gas diffusion layer 8, and thereby the reaction layer 10 is formed.

FIG. 9 is an end view of the substrate 2 on which the reaction layer 10 is formed. As shown in the FIG. 9, the platinum-carried carbon that carries fine platinum particles as the catalyst is coated on the gas diffusion layer 8, and thereby the reaction layer 10 is formed. In FIG. 9, in order that the reaction layer 10 and the gas diffusion layer 8 may be easily discriminated, as the reaction layer 10, the fine platinum particles alone are shown. Furthermore, in the drawings below too, the reaction layers are depicted similarly to FIG. 9. The substrate 2 on which the reaction layer 10 is formed is transferred from the table 28 to the belt conveyer BC1 followed by transferring to the discharge device 20g by means of the belt conveyer BC1.

In the next place, on the reaction layer 10 formed in the step S14, an electrolyte film, such as an ion exchange membrane and so on is formed (step S15). That is, first, the substrate 2 transferred up to the discharge device 20g by technique of the belt conveyer BC1 is placed on the table 28 and taken into the discharge device 20g. In the discharge device 20g, material that is reserved in the tank 30 and is used to form an electrolyte film, such as ones obtained by adjusting ceramic solid electrolyte, such as Nafion (registered trade mark), tungstophosphoric acid, molybdophosphoric acid and so on to a predetermined viscosity is discharged through the nozzles on the nozzle formation surface 26 on the reaction layer 10, and thereby an electrolyte film 12 is formed.

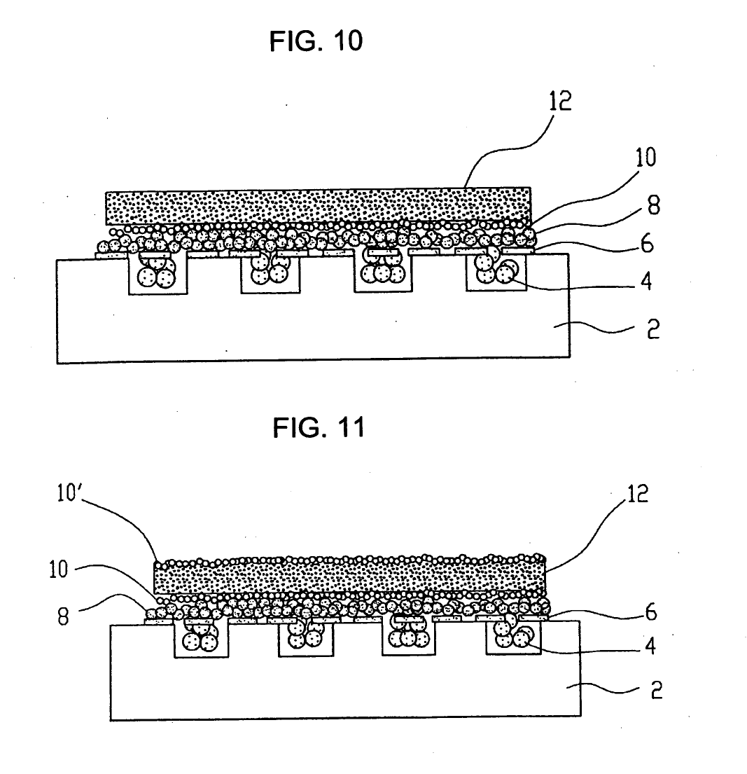

FIG. 10 is an end view of the substrate 2 on which the electrolyte film 12 is formed. As shown in the FIG. 10, the electrolyte film 12 having a predetermined thickness is formed on the reaction layer 10. The substrate 2 on which the electrolyte film 12 is formed is transferred from the table 28 to the belt conveyer BC1 followed by transferring to the discharge device 20h by technique of the belt conveyer BC1.

In the next place, on the electrolyte film 12 formed in the step S15, a reaction layer (second reaction layer) is formed (step S16). That is, the substrate 2 transferred up to the discharge device 20h by technique of the belt conveyer BC1 is placed on the table 28 and taken into the discharge device 20h. In the discharge device 20h, according to the similar treatment as that carried out in the discharge device 20f, carbon that carries fine platinum particles as the catalyst is discharged, and thereby a reaction layer 10′ is formed.

FIG. 11 is an end view of the substrate 2 where the reaction layer 10′ is formed on the electrolyte film 12. As shown in the FIG. 11, the carbon that carries fine platinum particles as the catalyst is coated on the electrolyte film 12, and thereby the reaction layer 10′ is formed. Here, the reaction layer 10′ is one where the second reaction gas, such as a reaction gas containing oxygen, reacts.

In the next place, on the reaction layer 10′ formed in the step S16, a gas diffusion layer that causes the diffusion of the reaction gas (second reaction gas) is formed (step S17). That is, the substrate 2 on which the reaction layer 10′ is formed is transferred up to the discharge device 20i by means of the belt conveyer BC1, and in the discharge device 20i, according to the similar treatment as that carried out in the discharge device 20e, porous carbon having a predetermined particle size is coated, and thereby a gas diffusion layer 8′ is formed.

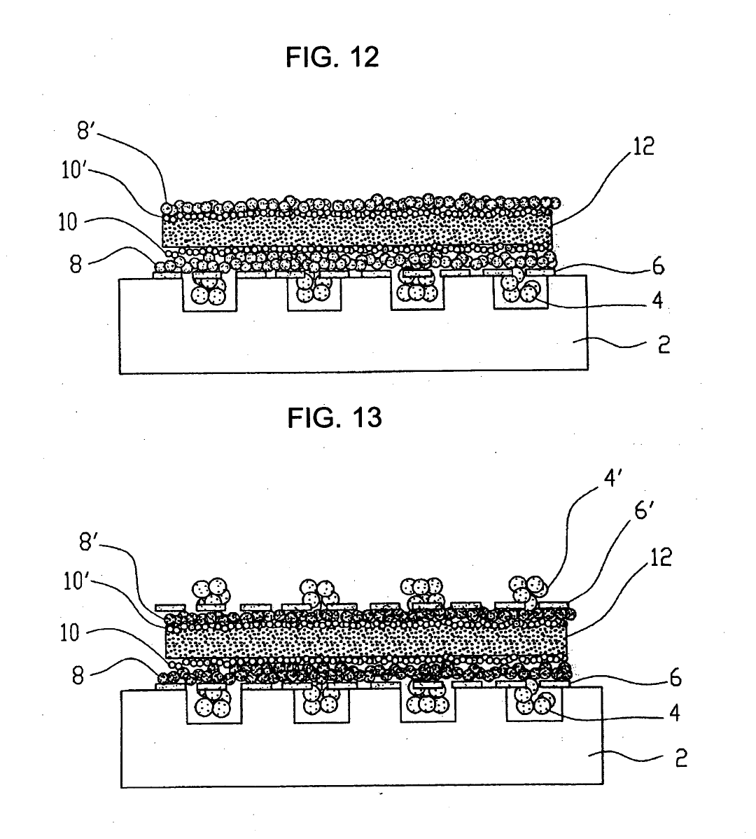

FIG. 12 is an end view of the substrate 2 where the gas diffusion layer is formed on the reaction layer 10′. As shown in the FIG. 12, the porous carbon is coated on the reaction layer 10′, and thereby a gas diffusion layer 8′ is formed.

In the next place, on the gas diffusion layer 8′ formed in the step S17, a current collecting layer (second current collecting layer) is formed (step S18), on the current collecting layer supporting carbon (second supporting member) for supporting the current collecting layer is coated (step S19). That is, the substrate 2 transferred up to the discharge device 20j by technique of the belt conveyer BC1 is placed on the table 28 and taken into the discharge device 20j, according to the similar treatment as that carried out in the discharge device 20d, a current collecting layer 6′ is formed on the gas diffusion layer 8′. Furthermore, the substrate 2 transferred up to the discharge device 20k by technique of the belt conveyer BC1 is placed on the table 28 and taken into the discharge device 20k, according to the similar treatment as that carried out in the discharge device 20c, supporting carbon 4′ is coated. The substrate 2 on which the supporting carbon 4′ is coated is transferred from the table 28 to the belt conveyer BC1 followed by transferring to an assembly unit 60.

FIG. 13 is an end view of the substrate 2 where the current collecting layer 6′ and the supporting carbon 4′ are coated on the gas diffusion layer 8′. As shown in the FIG. 13, the current collecting layer 6′ is formed according to the treatment of the step S18 and the supporting carbon 4′ is coated according to the treatment of the step S19. Here, the supporting carbon 4′, similarly to the supporting carbon 4, is coated along the gas flow path formed on the substrate 2.

In the next place, on the substrate on which the supporting carbon was coated in step S19 (the first substrate), the substrate on which the gas flow path was formed (the second substrate) is disposed, and thereby a fuel cell is assembled (step S20). That is, in an assembly unit 60, on the substrate 2 (the first substrate) transferred through the belt conveyer BC1, the substrate 2′ (the second substrate) transferred through a belt conveyer BC2 is disposed, and thereby a fuel cell is assembled. Here, on the substrate 2′, separately from treatments in the steps S10 through S19, a second gas flow path is formed. That is, in the discharge devices 20l and 20m, according to the treatments similar to that carried out by the discharge devices 20a and 20b, the second gas flow path is formed. Accordingly, the substrate 2′ is disposed so that the gas flow path that is formed on the substrate 2, extends from one side surface to the other side surface thereof and has a U-shaped cross section may be in parallel with the gas flow path that is formed on the substrate 2′ and has a U-shaped cross section, followed by assembling a fuel cell, and thereby the manufacture of the fuel cell comes to completion.

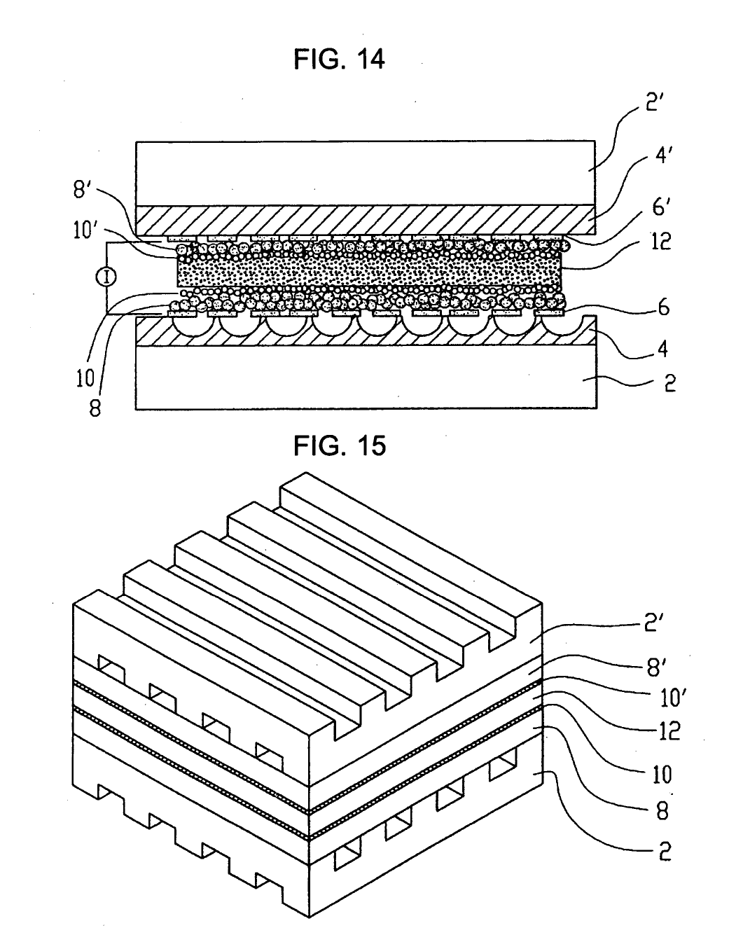

FIG. 14 is an end view of a manufactured fuel cell. As shown in the FIG. 14, when the substrate 2′ on which the second gas flow path is formed is disposed on a predetermined position of the substrate 2 on which the supporting carbon 4′ is coated, the manufacture of the fuel cell in which the first reaction gas is supplied through the first gas flow path formed on the first substrate and the second reaction gas is supplied through the second gas flow path formed on the second substrate comes to completion.

The fuel cell manufactured according to the above manufacturing method can be assembled as a power source in electronics devices, in particular, portable electronics devices such as portable telephones and so on. That is, according to the above fuel cell manufacturing method, a small size fuel cell can be easily manufactured by use of the discharge device; accordingly, it can be assembled as a power source in, for instance, small size electronics devices such as portable telephones and so on.

According to the fuel cell manufacturing apparatus involving the present embodiment, by use of a manufacturing line in which ink jet type discharge devices are sequentially disposed, a fuel cell is manufactured. Accordingly, operations in the respective steps in the manufacture of the fuel cell can be continuously carried out, resulting in improving in the working efficiency and the productivity. Furthermore, the substrate is transferred by use of a belt conveyer between the respective discharge devices that are continuously disposed. Accordingly, the substrate can be smoothly transferred between the respective discharge devices and the treatments at the respective discharge devices can be continuously carried out, resulting in improving the productivity.

Furthermore, according to the fuel cell manufacturing method involving the present mode for carrying out the invention, a gas flow path is formed on a substrate by use of an ink jet type discharge device, and thereby a fuel cell is manufactured. Accordingly, without employing the microfabrication technology such as the MEMS and so on that are used in the semiconductor process, the fine gas flow path can be formed on the substrate, resulting in manufacturing a highly efficient fuel cell at low costs.

Still furthermore, according to the fuel cell manufacturing method involving the mode for carrying out the invention, a reaction layer is formed by means of an ink jet type discharge device, and thereby a fuel cell is manufactured. Accordingly, even when an expensive material such as platinum is used as material of catalyst, since a necessary amount of the catalyst can be accurately discharged at a predetermined position, an amount of catalyst used can be inhibited from unnecessarily increasing, resulting in manufacturing a fuel cell at low costs. Furthermore, when the catalyst is coated by use of the ink jet type discharge device, the catalyst can be uniformly coated on the gas diffusion layer, resulting in improving the performance of a fuel cell.

Still furthermore, according to the fuel cell manufacturing method involving the mode for carrying out the invention, an electrolyte film is formed by use of the ink jet type discharge device, and thereby a fuel cell is manufactured. Accordingly, since there is no need of pressure bonding the electrolyte film, the electrolyte film can be inhibited from being damaged. Furthermore, material for forming the electrolyte film is coated on the reaction layer, and thereby the electrolyte film is formed. Accordingly, by use of simple operation steps a fuel cell can be manufactured.

In the fuel cell manufacturing method involving the above mode for carrying out the invention, in each of all steps, an ink jet type discharge device is used; however, by using an ink jet type discharge device in any one of the steps, a fuel cell may be manufactured. For instance, a fuel cell may be formed by forming a gas flow path by use of an ink jet type discharge device and by using conventional steps in other steps. Even in this case, without employing the MEMS, the gas flow path can be formed. Accordingly, the manufacturing cost of the fuel cell can be suppressed low.

Furthermore, in the fuel cell manufacturing method involving the mode for carrying out the invention, the gas flow path is formed by coating a resist solution on a substrate followed by further coating an aqueous solution of hydrofluoric acid to etch. However, without coating the resist solution, the gas flow path may be formed. For instance, by use of an ink jet type discharge device, an aqueous solution of hydrofluoric acid is discharged on a predetermined position on the substrate, and thereby a gas flow path may be formed. Still furthermore, a gas flow path may be formed by placing a substrate in an atmosphere of fluorine followed by discharging water on a predetermined position on the substrate. In this case, an aqueous solution of hydrofluoric acid obtained by discharging water in an atmosphere of fluorine is coated on the substrate, and thereby the gas flow path is formed.

Still furthermore, in the fuel cell manufacturing method according to the mode for carrying out the invention, the first substrate to which the first reaction gas is supplied is manufactured first, however, the second substrate to which the second reaction gas is supplied may be manufactured first. That is, the manufacture of a fuel cell may be started from the manufacture of the substrate to which the second reaction gas containing oxygen is supplied. In this case, in the discharge devices 20a through 20k, predetermined treatments are applied to the second substrate, and in the discharge devices 20l and 20m predetermined treatments are applied to the first substrate.

Furthermore, in the fuel cell manufacturing method according to the mode for carrying out the invention, the second gas flow path is formed on the second substrate similarly to the first gas flow path that is formed on the first substrate, however, the second gas flow path may be formed in a direction that intersects with that of the first gas flow path. That is, the resist solution may be coated in a direction that extends from a right side surface to a left side surface in the drawing of, for instance FIG. 4B so as to, for instance, intersect perpendicularly with the gas flow path formed on the first substrate. In this case, the second substrate is disposed so that the second gas flow path formed on the second substrate and the first gas flow path formed on the first substrate may intersect with a right angle to each other.

Still furthermore, in the fuel cell manufacturing method according to the mode for carrying out the invention, on the first substrate on which the gas flow path is formed, the current collecting layer, the reaction layer, the electrolyte film, the reaction layer and the current collecting layer are formed, however, on each of the first and second substrates, a current collecting layer, a reaction layer and an electrolyte film may be formed. That is, firstly, on a first substrate, a first gas flow path for supplying a first reaction gas is formed, and on the first substrate on which the first gas flow path is formed, a first current collecting layer is formed. Subsequently, on the first current collecting layer, a first reaction layer is formed, and on the first reaction layer, an electrolyte film is formed. Furthermore, also as to a second substrate, a second gas flow path is formed followed by forming a second current collecting layer further followed by forming a second reaction layer on the second current collecting layer still furthermore followed by forming an electrolyte film on the second reaction layer. Subsequently, the first substrate on which the first gas flow path, the first current collecting layer, the first reaction layer and the electrolyte film are formed and the second substrate on which the second gas flow path, the second current collecting layer, the second reaction layer and the electrolyte film are formed are connected with the formed electrolyte films intervened therebetween, and thereby a fuel cell may be manufactured. Here, a first manufacturing line that processes the first substrate and a second manufacturing line that processes the second substrate may be disposed and treatments in the respective manufacturing lines may be performed in parallel. In this case, the treatment to the first substrate and that to the second substrate can be carried out in parallel; accordingly, a fuel cell can be rapidly manufactured.

Furthermore, in the fuel cell manufacturing method involving the mode for carrying out the invention, a small size fuel cell is manufactured, however, by laminating a plurality of fuel cells, a large size fuel cell may be manufactured. That is, as shown in FIG. 15, when a gas flow path is formed on a back surface of a substrate 2′ of a manufactured fuel cell, and on the back surface of the substrate 2′ on which the gas flow path is formed, similarly to the manufacturing steps in the above manufacturing method of a fuel cell a gas diffusion layer, a reaction layer, an electrolyte film and so on are formed followed by laminating the fuel cells, a large size fuel cell can be manufactured. When a large size fuel cell is manufactured like this, it can be used as a power source of, for instance, an electric car. Accordingly, a clean energy automobile that appropriately cares for the global environment can be provided.

According to fuel cell manufacturing apparatus according to the invention, at least one of a first gas flow path formation unit, a first current collecting layer formation unit, a first reaction layer formation unit, an electrolyte film formation unit, a second gas flow path formation unit, a second current collecting layer formation unit and a second reaction layer formation unit includes a discharge device, and the respective units are continuously disposed as a manufacturing line. Accordingly, the manufacture of a fuel cell can be continuously carried out, and an improvement in the productivity of the fuel cell results.

According to the fuel cell manufacturing method according to the invention, a step of forming a first gas flow path, a step of forming a first current collecting layer, a step of forming a first reaction layer, a step of forming an electrolyte film, a step of forming a second gas flow path, a step of forming a second current collecting layer and a step of forming a second reaction layer are continuously carried out by use of the fuel cell manufacturing apparatus according to the invention. Accordingly, the productivity of a fuel cell can be improved and a fuel cell can be manufactured at low costs.

According to the fuel cell manufacturing method according to the invention, at least one of the step of forming a first gas flow path, the step of forming a first current collecting layer, the step of forming a first reaction layer, the step of forming an electrolyte film, the step of forming a second gas flow path, the step of forming a second current collecting layer and the step of forming a second reaction layer is carried out by use of a discharge device. Accordingly, without employing, for instance, the MEMS that is used in the semiconductor process, a fine gas flow path can be formed by use of the ink jet type discharge device. Accordingly, a fuel cell can be manufactured at low costs. Furthermore, since a fine gas flow path can be manufactured, a high performance fuel cell can be easily manufactured.

According to an electronics device according to the invention, a fuel cell that is manufactured according to the fuel cell manufacturing method involving the invention is used as a power source. Accordingly, when the electronics devices such as portable telephones and so on are discarded, there is no concern of poisonous materials and so on flowing out. Furthermore, according to an automobile according to the invention, a fuel cell that is manufactured according to the fuel cell manufacturing method involving the invention is used as a power source. Accordingly, when the fuel cell is used as a power source in, for instance, an electric car, an automobile that does not exhaust a waste gas can be provided. As a result, clean energy that appropriately cares for the global environment can be realized.

Thus, while this invention has been described in conjunction with specific embodiments thereof, it is evident that many alternatives, modifications, and variations will be apparent to those skilled in the art. Accordingly, preferred embodiments of the invention as set forth herein are intended to be illustrative not limiting. Various changes may be made without departing from the spirit and scope of the invention.

What is claimed is:

1. A fuel cell manufacturing apparatus, comprising:
a first gas flow path formation unit that forms on a first substrate a first gas flow path that supplies a first reaction gas;
a first current collecting layer formation unit that forms a first current collecting layer that collects electrons generated by a reaction of the first reaction gas supplied through the first gas flow path;
a first reaction layer formation unit that forms a first reaction layer where a reaction is performed based on the first reaction gas supplied through the first gas flow path;
an electrolyte film formation unit that forms an electrolyte film;
a second gas flow path formation unit that forms on a second substrate a second gas flow path that supplies a second reaction gas;
a second current collecting layer formation unit that forms a second current collecting layer that collects electrons generated by a reaction of the second reaction gas supplied through the second gas flow path; and
a second reaction layer formation unit that forms a second reaction layer where a reaction is performed based on the second reaction gas supplied through the second gas flow path,
at least one of the first gas flow path formation unit, the first current collecting layer formation unit, the first reaction layer formation unit, the electrolyte film formation unit, the second gas flow path formation unit, the second current collecting layer formation unit and the second reaction layer formation unit including a discharge device.

2. The fuel cell manufacturing apparatus, as set forth in claim 1:
the first gas flow path formation unit, the first current collecting layer formation unit, the first reaction layer formation unit, the electrolyte film formation unit, the second gas flow path formation unit, the second current collecting layer formation unit and the second reaction layer formation unit being continuously disposed as a manufacturing line.

3. The fuel cell manufacturing apparatus, as set forth in claim 1:
the respective units of the first gas flow path formation unit, the first current collecting layer formation unit, the first reaction layer formation unit, the electrolyte film formation unit, the second gas flow path formation unit, the second current collecting layer formation unit and the second reaction layer formation unit being coupled via a transfer unit.

4. A method of manufacturing a fuel cell in which method the fuel cell manufacturing apparatus, as set forth in claim 1, is used:
the step of forming the first gas flow path, the step of forming the first current collecting layer, the step of forming the first reaction layer, the step of forming the electrolyte film, the step of forming the second gas flow path, the step of forming the second current collecting layer and the step of forming the second reaction layer being continuously carried out.

5. A method of manufacturing a fuel cell, comprising:
forming a first gas flow path by which a first gas flow path that supplies a first reaction gas is formed on a first substrate;
forming a first current collecting layer by which a first current collecting layer that collects electrons generated by a reaction of a first reaction gas supplied through the first gas flow path is formed;
forming a first reaction layer by which a first reaction layer where a reaction is carried out based on the first reaction gas supplied through the first gas flow path is formed;
forming an electrolyte film by which an electrolyte film is formed;
forming a second gas flow path by which a second gas flow path that supplies a second reaction gas is formed on a second substrate;
forming a second current collecting layer by which a second current collecting layer that supplies electrons necessary for a reaction of the second reaction gas supplied through the second gas flow path is formed; and
forming a second reaction layer by which a second reaction layer where a reaction is carried out based on the second reaction gas supplied through the second gas flow path is formed;
at least in one step of the step of forming a first gas flow path, the step of forming the first current collecting layer, the step of forming the first reaction layer, the step of forming the electrolyte film, the step of forming the second gas flow path, the step of forming the second current collecting layer and the step of forming the second reaction layer, a discharge device is used.

6. The method of manufacturing a fuel cell, as set forth in claim 5:
in the step of forming a first current collecting layer, a first current collecting layer is formed on the first substrate;
in the step of forming the first reaction layer, a first reaction layer is formed on the first current collecting layer;
in the step of forming the electrolyte film, an electrolyte film is formed on the first reaction layer;
in the step of forming the second reaction layer, a second reaction layer is formed on the electrolyte film;
in the step of forming the second current collecting layer, a second current collecting layer is formed on the second reaction layer; and
the second substrate being disposed on the second current collecting layer.

7. The method of manufacturing a fuel cell, as set forth in claim 5:
the first current collecting layer, the first reaction layer and the electrolyte film are sequentially formed on the first substrate;
the second current collecting layer, the second reaction layer and the electrolyte film are sequentially formed on the second substrate; and
the electrolyte film of the first substrate and the electrolyte film of the second substrate are connected.

8. The method of manufacturing a fuel cell, as set forth in claim 5, further comprising:
disposing a first supporting member by which a first supporting member that supports the first current collecting layer is disposed in the first gas flow path that is formed in the step of forming a first gas flow path; and
disposing a second supporting member by which a second supporting member that supports the second current collecting layer is disposed in the second gas flow path that is formed in the step of forming a second gas flow path.

9. A method of manufacturing a fuel cell in which at least one current collecting layer, at least one gas diffusion layer, at least one reaction layer and an electrolyte film are formed between two substrates:
in a step of forming at least one layer of the current collecting layer, the gas diffusion layer, the reaction layer and the electrolyte layer, a discharge device is used.

10. The method of manufacturing a fuel cell, as set forth in claim 9:
the gas diffusion layer being formed on the current collecting layer;
the reaction layer being formed on the gas diffusion layer; and
the electrolyte layer being formed on the reaction layer.

11. A method of manufacturing a fuel cell in which between a pair of substrates, having a gas flow path formed thereon, at least one current collecting layer, at least one gas diffusion layer, at least one reaction layer and an electrolyte film are formed:
in a step of forming at least one of the supporting member that is disposed in the gas flow path, the current collecting layer, the gas diffusion layer, the reaction layer and the electrolyte layer, a discharge device is used.

12. The method of manufacturing a fuel cell, as set forth in claim 11:
the current collecting layer being formed on the supporting member;
the gas diffusion layer being formed on the current collecting layer;
the reaction layer being formed on the gas diffusion layer; and
the electrolyte film being formed on the reaction layer.

13. An electronics device comprising a fuel cell manufactured according to the manufacturing method set forth in claim 5 as a power source.

14. An automobile comprising a fuel cell manufactured according to the manufacturing method set forth in claim 5 as a power source.
